(19) United States
(12) Patent Application Publication
(10) Pub. No.: US 2016/0025503 A1
(43) Pub. Date: Jan. 28, 2016

(54) VEHICLE PARKING MANAGEMENT

(71) Applicant: Ford Global Technologies, LLC, Dearborn, MI (US)

(72) Inventors: Donatus Andreas Josephine Kees, Billericay (GB); Anthemios Philemon Petridis, Bishop's Stortford (GB)

(21) Appl. No.: 14/339,803

(22) Filed: Jul. 24, 2014

(51) Int. Cl. G01C 21/34

(52) U.S. Cl. CPC G01C 21/34

(57) ABSTRACT

A final destination for a vehicle is used to identify a set of parking spaces. One of the parking spaces is selected based at least in part on at least one user parameter and data derived from historical data about the parking spaces. A route to the selected parking space is determined.

### BACKGROUND

Parking for vehicles such as automobiles, motorbikes, etc., can be limited and/or difficult to find in urban and/or congested areas. Further, a vehicle driver may be aware of only a limited subset of available parking spaces in an area near a vehicle's destination. Drivers can waste time and fuel, and can increase urban congestion and pollution, by driving around an area near a destination looking for a parking space.

Moreover, even if data concerning the availability of parking spaces can be provided to a vehicle, such data is of limited usefulness because it may be out-of-date by the time a vehicle reaches a parking space. That is, a vehicle approaching a destination may be informed that a parking space is available, but may find that the parking space is unavailable when the vehicle reaches the destination. Further, if a parking space is currently occupied, but likely to become available within a relatively short time, the vehicle driver has no way of knowing of the likely availability of the currently-occupied parking space. Accordingly, there is a need for improved systems and methods for managing vehicle parking, e.g., providing vehicles with more accurate and useful information concerning likely availability of parking spaces at a vehicle's intended destination.

### DRAWINGS

FIG. 1 is a block diagram of an example system for vehicle parking management.

FIG. 2 is a diagram of an example process for vehicle parking management.

### DETAILED DESCRIPTION

### System Overview

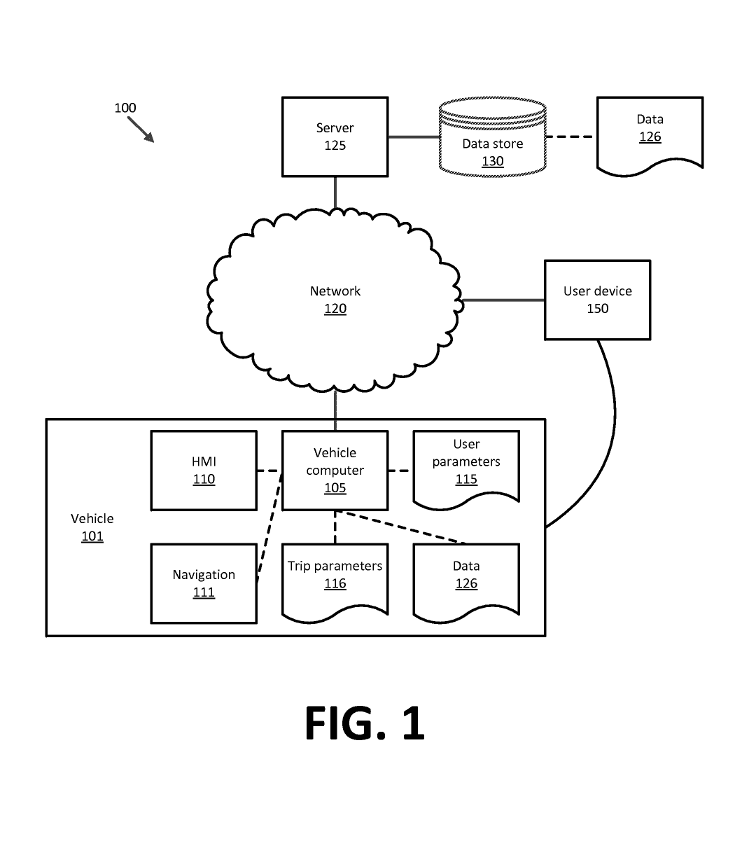

FIG. 1 is a block diagram of an example system 100 for vehicle 101 parking management. A vehicle 101 computer 105 is programmed to receive inputs providing trip parameters 116, e.g., from a vehicle 101 driver via a human-machine interface (HMI) 110, indicating an intended destination for the vehicle 101, a duration of a stay at the intended destination, e.g., a length of time for which parking may be needed, etc. A navigation system 111 that is included in or communicatively coupled to the computer 105 generates additional trip parameters 116, including a route to, and estimated time of arrival (ETA) at, the intended destination of the vehicle 101.

Based on the intended destination, stored user parameters 115, and also parking data 126 received from a remote server 125 via a network 120, the computer 105 identifies a destination parking space for the vehicle 101. The destination parking space is identified at least in part based on a computed probability that the destination parking space will be available at the ETA of the vehicle 101 at the intended destination. Alternatively or additionally, a destination parking space may be identified at least in part based on a computed probability that a waiting time at the destination parking space will be minimal. Further, as the vehicle 101 progresses on the route to the intended destination, the computer 105 may recompute probabilities of availability and/or waiting times at possible destination parking spaces, and may reroute the vehicle 101 to a different destination parking space based on at least one of a changed ETA, a changed route, a changed probability of parking spaces' availabilities, etc.

### System Elements

A vehicle 101 computer 105 generally includes a processor and a memory, the memory including one or more forms of computer-readable media, and storing instructions executable by the processor for performing various operations, including as disclosed herein. The memory of the computer 105 further generally stores user parameters 115, which may be provided in a variety of ways, e.g., via the HMI 110, a remote user device 150 such as a smart phone or the like, etc. The memory of the computer 105 also generally stores parking data 126. In addition, the memory of the computer 105 may store various data, including data relating to a vehicle 101 location provided by the navigation system 111, and other data collected from vehicle 101 controllers, sensors, etc.

Accordingly, the computer 105 is generally configured for communications on a controller area network (CAN) bus or the like, and/or may use other wire or wireless protocols, e.g., Bluetooth, etc. That is, the computer 105 can communicate via various mechanisms that may be provided in the vehicle 101 and/or other devices such as a user device 150. The computer 105 may also have a connection to an onboard diagnostics connector (OBD-II) port, e.g., according to the J1962 standard. Via the CAN bus, OBD-II connector port, and/or other wired or wireless mechanisms, the computer 105 may transmit messages to various devices in a vehicle and/or receive messages from the various devices, e.g., controllers, actuators, sensors, etc. In addition, the computer 105 may be configured for communicating, e.g., with one or more remote servers 125, with the network 120, which, as described below, may include various wired and/or wireless networking technologies, e.g., cellular, Bluetooth, wired and/or wireless packet networks, etc.

An HMI 110 included in or associated with the computer 105 may include a variety of known mechanisms for allowing a user to interface with the computer 105. For example, the HMI 110 could include a microphone, a speaker, text to speech, speech recognition processing capability, etc., for allowing verbal and/or audio interaction with the computer 105, e.g., in the form of an interactive voice response (IVR) system such as is known. Further, the HMI 110 could include a visual display, touchscreen, or the like, and/or other input/output mechanisms.

The navigation system, e.g., global positioning system (GPS), 111 is generally known for a variety of operations. These include using GPS satellites to determine geo-coordinates, i.e., latitude and longitude, of a vehicle 101. The GPS 111 may also receive input, e.g., a street address or the like, of an intended destination of a vehicle 101. Further, the GPS 111 may generate a route to be followed to the intended destination.

As mentioned above, the HMI 110 may be used to receive inputs from a user such as a vehicle 101 driver, including user parameters 115. User parameters 115 may include a variety of data pertaining to a particular user, e.g., vehicle 101 driver. The parameters 115 can include one or more of the following:
a maximum walking distance acceptable to the user from a parking space to a destination;
a maximum walking time acceptable to the user from a parking space to a destination;
acceptable payment methods for a parking space, e.g., payment through a dedicated application in the computer 105 and/or a user device 150, credit card payment, cash payment, change in a parking meter, etc.;
acceptable types of parking space facility, e.g., street parking, locked parking, garage parking, etc.;
required parking space amenities, e.g., electric vehicle charging station, handicapped parking, expectant mother parking, etc.;

As also mentioned above, the HMI 110 may further be used to receive inputs from a vehicle 101 driver or other user providing trip parameters 116. These may include the following:
An intended final destination of the user of the vehicle 101, i.e., after the vehicle 101 is parked, e.g., an address and/or geo-coordinates of a shopping center, theater, house, apartment building, etc.;
An intended duration of parking, i.e., a length of time the user will stay at the intended destination;
A planned time of arrival at the final destination.

The network 120 represents one or more mechanisms by which a vehicle 101 computer 105 may communicate with a remote server 125, including to obtain parking data 126. Accordingly, the network 120 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

The server 125 may be one or more computer servers, each generally including at least one processor and at least one memory, the memory storing instructions executable by the processor, including instructions for carrying out various of the steps and processes described herein. The server 125 includes or is communicatively coupled to a data store 130 for storing remote data 126.

Parking data 126 generally indicates parking spaces available within a defined geographic area. Further, the parking data 126 generally includes data obtained from sensors associated with individual parking spaces in the geographic area. For example, a parking system including such data is currently being installed in Westminster, London, United Kingdom. Sensor data can indicate whether a given parking space is occupied or unoccupied at a given time. Such sensor data may be communicated, e.g., via the network 120 or the like, to the server 125, and stored in the data store 130. Further, parking data 126 may include data derived from and/or calculated from the sensor data from parking spaces, e.g., data indicating an average amount of time that a parking space is occupied, e.g., at a particular time of day, a likelihood that the parking space will be occupied, e.g., at a particular time of day and/or day of the week, etc.

A user device 150 may be any one of a variety of computing devices including a processor and a memory, as well as communication capabilities. For example, the user device 150 may be a portable computer, tablet computer, a smart phone, etc. that includes capabilities for wireless communications using IEEE 802.11, Bluetooth, and/or cellular communications protocols. Further, the user device 150 may use such communications capabilities to communicate via the network 120 and also directly with a vehicle computer 105, e.g., using an in-vehicle communications mechanism, e.g., Bluetooth. Accordingly, the computer 105 could control access to one or more applications on a device 150 accessed via an HMI 110 connected to computer 105.

### Process

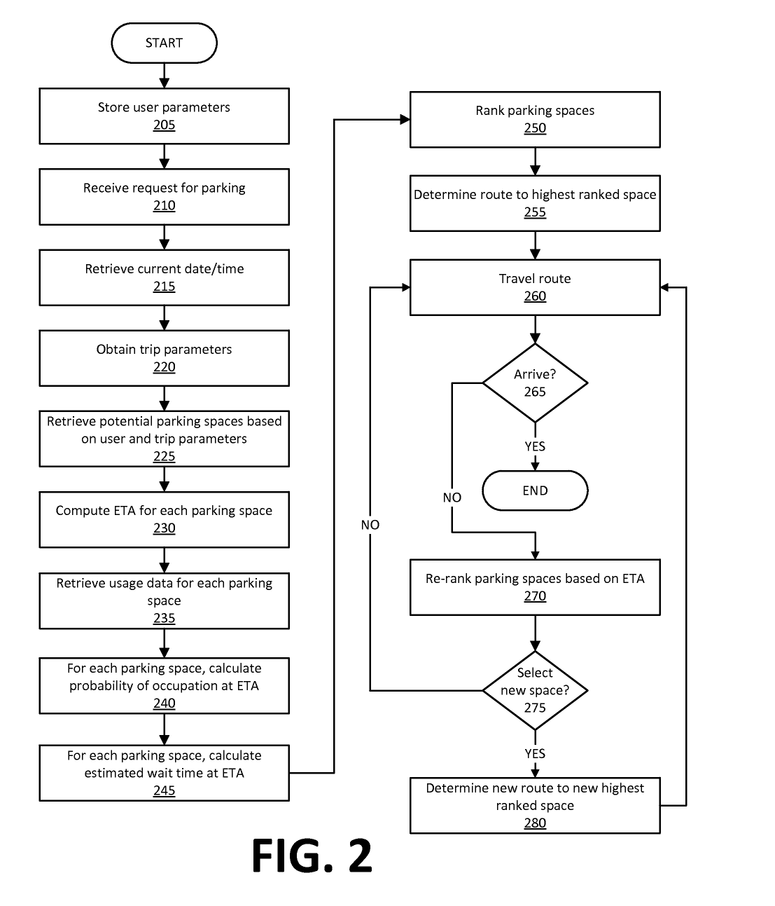

FIG. 2 is a diagram of an example process 200 for vehicle 101 parking management. The process 200 begins in a block 205, in which the computer 105 stores user parameters 115, e.g., received via the HMI 110.

Next, in a block 210, the computer 105 receives a request for a parking space. For example, user input could indicate that the vehicle 101 will be traveling to a final destination, and parking will be needed.

Next, in a block 215, the computer 105 retrieves a current date and/or time. For example, the navigation system 111, and in-dash radio in the vehicle 101, a user device 150, etc., could all provide a current date and/or time.

Next, in a block 220, the computer 105 obtains trip parameters 116, e.g., via the HMI 110.

Next, in a block 225, the computer 105 retrieves possible parking spaces for the vehicle 101 near a specified intended final destination, the potential parking spaces being identified from parking data 126 based on user parameters 115 and trip parameters 116. For example, a set of parking spaces P₁ . . . Pₙ may be identified that are within a walking distance and walking time of an intended final destination, and which can accommodate a payment method and required parking space facilities specified in user parameters 115. Note that, in some examples, multiple parking spaces could be treated as a single space for purposes of the process 200, e.g., multiple parking spaces in a single parking garage or carpark facility could be grouped together, and have historical data described below aggregated, averaged, etc., for purposes of the process 200.

Next, in a block 230, the computer 105 computes an ETA for each of the parking spaces identified in the block 225, e.g., spaces P₁ . . . Pₙ. For example, the computer 105 may obtain a driving route to each of the parking spaces identified from the navigation system 111, including a time to traverse such route, whereby an ETA for each of the parking spaces may be determined.

Next, in a block 235, the computer 105 obtains parking data 126 for each of the identified parking spaces, e.g., spaces P₁ . . . Pₙ, indicating a history of when each space was occupied. For example, the parking data 126 could indicate times when each parking space was occupied for a predetermined period of time, e.g., the previous week.

Next, in a block 240, the computer 105, for each of the parking spaces, e.g., spaces P₁ . . . Pₙ, determines a probability that the parking space will be free at the ETA of the vehicle 101 at the final destination specified in trip parameters 116. This probability determination is generally made using the historical parking data 126 obtained as described with respect to the block 235.

For example, a probability or likelihood that a parking space will be free at a particular time corresponding to the ETA of the vehicle 101 can be determined by accessing historic parking data 126 from previous days, weeks, months, etc., for a time period of, for example 15 minutes starting at the ETA of the vehicle 101. In the example, the time period is an estimate of variability of the predicted ETA due to traffic delays and can be estimated by the navigation system 111. It can be observed from the historic parking data for a given number of N previous days how many minutes during the 15 minute period beginning with the ETA the parking space was occupied, and for how many minutes it was not occupied. From this observation a probability that the parking space will be free at the ETA can be calculated by computing the sum of all minutes for the previous N days for which the parking space was not occupied, and dividing this sum by the product of the number of observed days (N) multiplied with the number of minutes available in the time period being observed, in this example 15 minutes. The probability determination can be refined by observing and comparing the parking data of matching days of the week to account for changes in parking space occupancy patterns. The previous process is given as an example; many variations and/or different processes are possible.

Next, in a block 245, for each of the identified parking spaces, the computer 105 calculates an estimated wait time for the vehicle 101 to obtain the parking space based on the ETA of the vehicle 101 at the final destination. For example, the likely waiting time could be determined according to an average wait time for the parking space during a specified period of time, e.g., the previous week at a specified time of day. As mentioned above, a probability or likelihood that a parking space will become free at a particular time corresponding to the ETA of the vehicle 101 can be determined by accessing historic parking data 126 from previous days, weeks, months, etc., for a time period of, for example, 15 minutes beginning with the ETA of the vehicle 101. The time period is an estimate of the variability of the predicted ETA due to traffic delays, and can be based on an estimate by the navigation system 111. Continuing with the example where the time period is 15 minutes, for each successive one-minute interval in the time period, e.g., minutes 1 to 15 within the time period of 15 minutes, it can be computed from the historic parking data, for a given number of N previous days, for how many minutes the parking space was occupied and for how many minutes it was not occupied. From this, the probability that the parking space will be free at the one-minute interval can be calculated by computing the sum of all minutes for the previous N days for which the parking space was not occupied and dividing this sum by the number of days N. In this manner the probability that a parking space will be free is determined for each one-minute time interval 1 to 15 beginning with the ETA. The estimated waiting time is found by adding the probability that a parking space will be free for time interval 1 to the subsequent time interval 2, and so on, until the probability that a parking space will be free reaches, or exceeds, 1. The number of time intervals required for this to occur can be multiplied by the duration of each time interval, in this example one minute, which defines the estimated waiting time in minutes for a parking space to become free. The process can be refined by observing and comparing the parking data of matching days of the week to account for changes in parking space occupancy patterns. Further, variations and different processes are possible.

Next, in a block 250, the computer 105 ranks each of the parking spaces, e.g., spaces P₁ . . . Pₙ, the ranking generally being done according to a likelihood that a parking space will be free at the specified ETA, along with a likely waiting time if the parking space is occupied. For example, a parking space that is most likely to be unoccupied at the ETA, and that has a shortest waiting time, is likely to be ranked first. Various weightings may be assigned to a likelihood that the parking space will be free and the likely waiting time, e.g., a likelihood that the parking space will be free may be given a higher weight, e.g., 0.75 and a lower weight given to a lower waiting time, e.g., 0.25, or other weights may be assigned as desired. In general, a higher weight or weights may be assigned for a situation in which a given ETA at a parking space P is associated with a high likelihood of the space P being free, combined with a high likelihood that the parking space P will have a low waiting time.

Next, in a block 255, the computer 105, e.g., from the navigation system 111, obtains a route to the highest-ranked parking space. The route generally includes an ETA at the highest-ranked parking space.

Then, in a block 260, the vehicle 101 proceeds on the route identified in the block 255.

Next, in a block 265, the computer 105 determines whether the vehicle 101 has arrived at the identified parking space and/or is within a predetermined distance or time of arrival, e.g., a 10^{th} of a mile, half a kilometer, two minutes, etc. If the vehicle 101 has arrived, then the process 200 ends. Otherwise, the process 200 proceeds to a block 270.

In a block 270, the computer 105 obtains an updated ETA at the identified parking space, e.g., from the navigation system 111. The computer 105 also generally obtains updated data 126 from the server 125. Based on the updated ETA and/or updated data 126, the computer 105 re-ranks the parking spaces identified in the block 225, e.g., spaces P₁ . . . Pₙ, e.g., in a manner described above with respect to the block 250.

Next, in a block 275, the computer 105 determines whether the re-ranking of the block 270 resulted in a new highest-ranked parking space being selected. If not, the process 200 returns to the block 270. If a new space has been selected, then the process 200 proceeds to a block 280.

In the block 280, the computer 105, e.g., from the navigation system 111, obtains a new route, i.e., a route to the new highest-ranked parking space. Following the block 280, the process 200 returns to the block 260 for the vehicle 101 to proceed on the new route.

As noted above, the process 200 ends following the block 265, when the vehicle 101 arrives at a selected parking space.

### Conclusion

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A system, comprising an in-vehicle computer comprising a processor and a memory, wherein the in-vehicle computer is programmed to:
receive a final destination for the vehicle;
identify a set of parking spaces based on the final destination;
select one of the parking spaces based at least in part on at least one user parameter and data derived from historical data about the parking spaces; and
determine a first route to the selected parking space.

2. The system of claim 1, wherein the computer is further programmed to, prior to determining the first route, to determine a second route, including a first estimated time of arrival (ETA), at the final destination.

3. The system of claim 2, wherein the computer is further programmed to use the first ETA in selecting the one of the parking spaces.

4. The system of claim 2, wherein the computer is further programmed to determine a second ETA at the selected parking space, based at least in part on the first route.

5. The system of claim 4, wherein the computer is further programmed to update, while the first route is being travelled, the second ETA to obtain a third ETA.

6. The system of claim 5, wherein the computer is further programmed to select a new one of the parking spaces based at least in part on the third ETA, the at least one user parameter, and the data derived from the historical data.

7. The system of claim 6, wherein the computer is further programmed to obtain a third route to the new one of the parking spaces.

8. The system of claim 1, wherein the historical data for a parking space includes at least one of data concerning times when the parking space was occupied and waiting times for the parking space to become unoccupied.

9. The system of claim 8, wherein the data derived from the historical data includes at least one of a probability that a parking space will be occupied at a given time, and a likely waiting time at a parking space at the given time.

10. The system of claim 1, wherein the at least one user parameter includes a maximum walking distance, a maximum walking time, an acceptable payment method, a type of parking facility, and a required parking facility amenity.

11. A method, implemented in an in-vehicle computer comprising a processor and a memory, the method comprising:
receiving a final destination for the vehicle;
identifying a set of parking spaces based on the final destination;
selecting one of the parking spaces based at least in part on at least one user parameter and data derived from historical data about the parking spaces; and
determining a first route to the selected parking space.

12. The method of claim 11, further comprising, prior to determining the first route, determining a second route, including an first estimated time of arrival (ETA), at the final destination.

13. The method of claim 12, further comprising using the first ETA in selecting the one of the parking spaces.

14. The method of claim 12, further comprising determining a second ETA at the selected parking space, based at least in part on the first route.

15. The method of claim 14, further comprising updating, while the first route is being travelled, the second ETA to obtain a third ETA.

16. The method of claim 15, further comprising selecting a new one of the parking spaces based at least in part on the third ETA, the at least one user parameter, and the data derived from the historical data.

17. The method of claim 16, further comprising obtaining a third route to the new one of the parking spaces.

18. The method of claim 11, wherein the historical data for a parking space includes at least one of data concerning times when the parking space was occupied and waiting times for the parking space to become unoccupied.

19. The method of claim 18, wherein the data derived from the historical data includes at least one of a probability that a parking space will be occupied at a given time, and a likely waiting time at a parking space at the given time.

20. The method of claim 11, wherein the at least one user parameter includes a maximum walking distance, a maximum walking time, an acceptable payment method, a type of parking facility, and a required parking facility amenity.
